(19) United States
(12) Patent Application Publication
(10) Pub. No.: US 2005/0131980 A1
(43) Pub. Date: Jun. 16, 2005

(54) Logical calculation architecture comprising multiple configuration modes

(75) Inventors: Lionel Torres, Combaillaux (FR); Gaston Cambon, Saint-Gely-du-Fesc (FR); Michel Robert, Saint Clement de Riviere (FR); Gilles Sassatelli, Nimes (FR); Jerome Galy, Juvignac (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignees: Centre National de la Recherche Scientifique-CNRS, an organization of France, Paris (FR); Universite de Montpellier II Sciences et Technique du Languedoc, an organization of France, Montpellier (FR)

(21) Appl. No.: 10/956,314

(22) Filed: Oct. 1, 2004

Related U.S. Application Data
(63) Continuation of application No. PCT/FR03/01050, filed on Apr. 3, 2003.

(30) Foreign Application Priority Data
Apr. 3, 2002 (FR) 02/04161

(51) Int. Cl. G06F 15/00

(52) U.S. Cl. 708/620

(57) ABSTRACT

A logical calculation architecture including a multiplicity of configurable calculation components; a multiplicity of interconnection components; a first set of signals that configure the architecture by connecting between the calculation components and the interconnection components; a processor that generates the first set of configuration signals; a multiplicity of configurable control components, each control component connected to one of the calculation components and the control components generating at least one calculation instruction for calculation components; and a second set of signals that configure the control components.

### RELATED APPLICATIONS

This is a continuation of International Application No. PCT/FR03/01050, with an international filing date of Apr. 3, 2003 (WO 03/083696, published Oct. 9, 2003), which is based on French Patent Application No. 02/04161, filed Apr. 3, 2002.

### FIELD OF THE INVENTION

This invention pertains to the field of programmable electronics. This invention pertains more particularly to the design of multilevel configuration modes.

### BACKGROUND

A noteworthy goal in this field is to make effective use of available time and space. Development efforts have focused on providing dynamically reconfigurable solutions, i.e., that can be implemented without stopping the calculations to achieve this goal. The simplest concept has been to configure one part of the architecture when another independent part is in the process of calculating.

U.S. Pat. No. 6,023,742 discloses a configurable calculation architecture the functionalities of which are controlled by a combination of static and dynamic controls. The static control is a configuration contained in a memory and the dynamic controls are signals sent by a controller and interpreted by a control pathway that configures the logical units as a function of these instructions. U.S. '742 proposes an architecture supporting two configuration levels: local and global. However, that architecture is not configured for logical elements working at the word level (e.g., on octets).

### SUMMARY OF THE INVENTION

This invention relates to a logical calculation architecture including a multiplicity of configurable calculation components; a multiplicity of interconnection components; a first set of signals that configure the architecture by connecting between the calculation components and the interconnection components; a processor that generates the first set of configuration signals; a multiplicity of configurable control components, each control component connected to one of the calculation components and the control components generating at least one calculation instruction for the calculation components; and a second set of signals that configure the control components.

### BRIEF DESCRIPTION OF DRAWINGS

Better understanding of the invention will be obtained from the description below presented for purely explanatory purposes of a selected mode of implementation of the invention, with reference to the attached figures:

FIG. 1 illustrates a “calculation unit-control unit” set; and

FIG. 2 illustrates a logical calculation set.

### DETAILED DESCRIPTION

This invention resolves drawbacks of the prior art by providing an architecture of configurable logical components comprising multiple configuration modes and using logical calculation components at the word level. The invention is remarkable in its broadest sense in that it pertains to a logical calculation architecture comprising:
a multiplicity of configurable calculation components;
a multiplicity of interconnection components;
a first set of signals intended to configure the architecture, i.e., the connections between the calculation components and the interconnection components;
a processor which generates the first set of configuration signals;
a multiplicity of configurable control components, each control component being connected to one of the calculation components and the control components being capable of generating at least one calculation instruction intended for the calculation components; and
a second set of signals intended to configure the control components.

The calculation components preferably perform calculations on data sets, each set comprising a multiplicity of bits. The control components are advantageously connected to the processor.

A configurable logical calculation architecture comprises two layers:
an operating layer comprising a network of calculation and routing units which performs the logical calculations on data provided by an external element; and
a configuration layer enabling, on the one hand, arrangement of the calculation and routing units to organize the direction of circulation of the data and, on the other hand, to configure the calculation units such that they can performed a predefined calculation.

In one implementation of this architecture, the configuration layer sends configuration information directly to constitutive elements of the calculation units. If this architecture comprises a large number of calculation and routing units, the configuration of the operating layer can be long. The architecture according to the invention allows the reconfiguration of the operating layer elements according to several modes: a global mode, a local mode and a hybrid mode. The reconfiguration according to each of the modes is dynamic.

The architecture implemented for the global mode comprises an operating layer, a configuration layer and a processor specific to the configuration operations referred to as the “configuration controller.” The configuration and operating layers are divided into groups, one group of the operating layer being configured by one group of the configuration layer. Each group of the operating layer comprises a multiplicity of configurable logical elements. One entire group of the operating layer is reconfigurable in each clock cycle.

While a calculation is performed by a first group of the operating layer, the configuration controller modifies the configuration of a group of the configuration layer corresponding to a second group of the operating layer. In the following clock cycle, the second group of the operating layer is reconfigured as a function of the group of the corresponding configuration layer. Moreover, the presence of a processor dedicated to management of the configuration allows management of the conditional configuration: the results calculated by the elements of the operating layer can influence the configuration of the architecture. The architecture puts in place a communication bus between the operating layer and the configuration controller to do this.

The architecture according to aspects of the invention furthermore pertains to the implementation of a local configuration mode. The architecture provides the addition of control units to the calculation units. These control units comprise a sequencer of at least one instruction (and preferably 8) and a finished machine state that enables knowledge of the state of the control unit at all times. The configuration layer sends to the control unit information comprising the control instructions of the calculation unit. The set of these instructions forms a microprogram. The sequencer then commands the sending of the microprogram to the calculation unit. The calculation unit thus performs a set of instructions requiring different configurations without calling up the configuration controller.

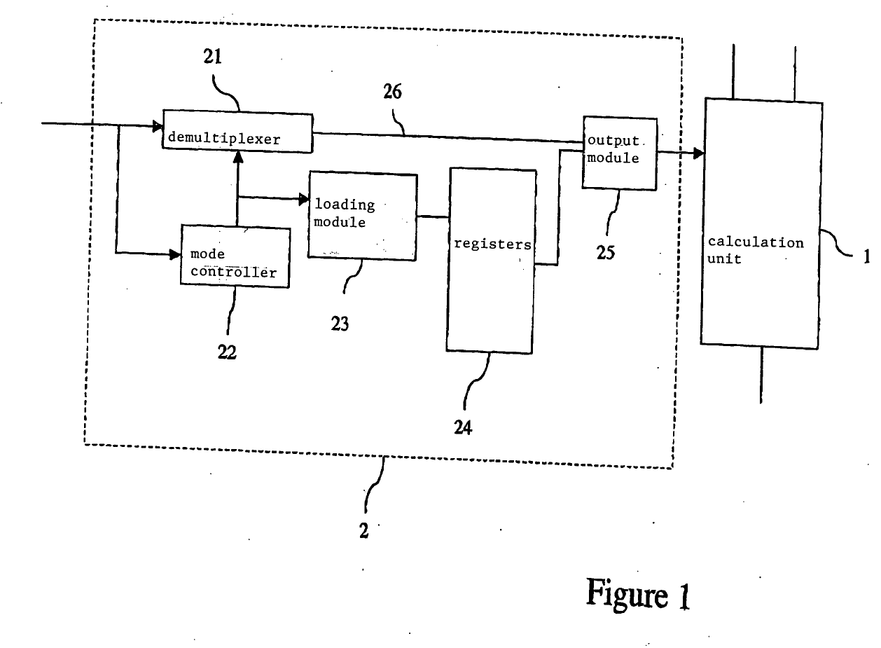

A “calculation unit-control unit” set is illustrated in FIG. 1. The calculation unit (1) is connected to at least one input data flow (3) and to at least one output data flow (4). It is furthermore connected to the control unit (2) via the connector (5). The control unit (2) is composed of a demultiplexer (21), a mode controller (22), a loading module (23), a set of registers (24) and an output module (25). According to the configuration mode of the architecture, the mode controller (22) commands the demultiplexer (21) to route the incoming configuration signal:
in global mode, i.e., in which the calculation unit (1) is configured directly by the configuration layer, the signal is transferred directly from the demultiplexer (21) to the output module (25) by the connector (26). The output module (25) transmits the configuration information to the calculation unit (1) via the connector (5);
in local mode, i.e., in which the calculation unit (1) is configured by the control unit (2), the demultiplexer (21) transmits the configuration information to the loading module (23) which then downloads the microprogram into the set of registers (24). Once loaded and under the control of an instruction specifying it, the microprogram is executed by the control unit.

Execution of the microprogram can follow two procedures:
the first procedure comprises execution of the instructions stored in the registers of the control unit a single time;
the second procedure comprises execution of instructions in loop mode, i.e., until the stopping of the execution by the configuration controller.

A supplementary register is present in the calculation unit, the supplementary register containing the end address of the microprogram.

Lastly, in another aspect of implementation of the architecture, certain logical calculation elements of the architecture are configured in a global manner while other logical elements are configured in a local manner.

This architecture is preferably implemented with a calculation unit that operates on bit words, i.e., on sets of bits. The calculations are more difficult to program in the calculation unit. However, a larger number of bits can be processed in each clock cycle which accelerates the calculation process. If use is made of a calculation by word architecture, the complexity of the calculations implemented makes the configuration more difficult. Use of an architecture according to aspects of the invention makes it possible to reduce the configuration difficulty of the architecture.

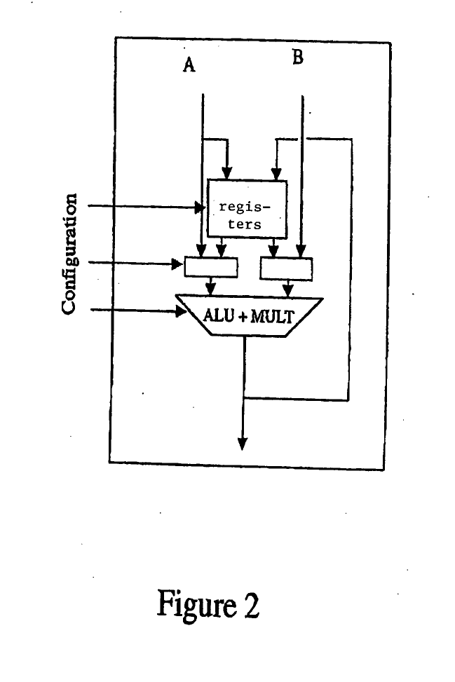

A logical calculation unit is illustrated in FIG. 2. The logical calculation unit is a dynamically reconfigurable unit capable of performing simple arithmetic and logical operations at the word level. This component comprises a multiplicity of registers (preferably 4), of a logical and arithmetic unit (ALU) including a multiplier and a state machine.

The invention was described above as an example. It is understood that one skilled in the art could implement different aspects of the invention without going beyond its scope as defined in the appended claims.

1. A logical calculation architecture comprising:
a multiplicity of configurable calculation components;
a multiplicity of interconnection components;
a first set of signals that configure the architecture by connecting between the calculation components and the interconnection components;
a processor that generates the first set of configuration signals;
a multiplicity of configurable control components, each control component connected to one of the calculation components and the control components generating at least one calculation instruction for calculation components; and
a second set of signals that configure the control components.

2. The logical calculation architecture according to claim 1, wherein the calculation components perform calculations on data sets, each set comprising a multiplicity of bits.

3. The logical calculation architecture according to claim 1, wherein the control components are connected to the processor.

4. The logical calculation architecture according to claim 2, wherein the control components are connected to the processor.

5. A logical calculation architecture comprising:
a multiplicity of configurable calculation components;
a multiplicity of interconnection components;
a first set of signals that configure the architecture through connections between the calculation components and the interconnection components;
a processor that generates the first set of configuration signals;
a multiplicity of configurable control components, each control component connected to one of the calculation components, and the control components generating at least one calculation instruction for the calculation components; and
a second set of signals that can configure the control components.

6. The logical calculation architecture according to claim 5, wherein the calculation components perform calculations on data sets, each set comprising a multiplicity of bits.

7. The logical calculation architecture according to claim 5, wherein the control components are connected to the processor.

8. The logical calculation architecture according to claim 6, wherein the control components are connected to the processor.
